(19) United States
(12) Patent Application Publication
(10) Pub. No.: US 2015/0069991 A1
(43) Pub. Date: Mar. 12, 2015

(54) POWER SUPPLY CIRCUIT

(71) Applicant: KABUSHIKI KAISHA TOSHIBA, Minato-ku (JP)

(72) Inventor: Takuyo KODAMA, Sagamihara-Shi (JP)

(73) Assignee: KABUSHIKI KAISHA TOSHIBA, Minato-ku (JP)

(21) Appl. No.: 14/144,755

(22) Filed: Dec. 31, 2013

Related U.S. Application Data
(60) Provisional application No. 61/875,301, filed on Sep. 9, 2013.

(51) Int. Cl. H02M 1/00

(52) U.S. Cl. CPC H02M 1/00
USPC 323/285

(57) ABSTRACT

The power supply circuit includes a power supply-side capacitor The power supply circuit includes a ground-side capacitor The power supply circuit includes a power supply-side amplifier that is connected to the voltage output terminal at a non-inverting input terminal thereof and to the second end of the power supply-side resistor at an inverting input terminal thereof and outputs a power supply-side control signal at an output terminal thereof. The power supply circuit includes a ground-side amplifier that is connected to the second end of the ground-side resistor at a non-inverting input terminal thereof, receives a ground-side detection voltage that is based on the output voltage at an inverting input terminal thereof and outputs a ground-side control signal.

### CROSS-REFERENCE TO RELATED APPLICATION

This application is based upon and claims the benefit of U.S. provisional Application No. 61/875,301, filed on Sep. 9, 2013, the entire contents of which are incorporated herein by reference.

### BACKGROUND

1. Field

Embodiments described herein relate generally to a power supply circuit.

2. Background Art

A conventional power supply circuit is provided with a regulator to cope with a drop of a power supply voltage. The regulator of the conventional power supply circuit induces an overshot and takes longer to stabilize the output voltage, if the response speed is increased.

### BRIEF DESCRIPTION OF THE DRAWINGS

FIG. 1 is a circuit diagram showing an example of a configuration of a power supply circuit 100 according to a first embodiment;

FIG. 2 is a waveform diagram showing an example of the output voltage “VOUT” in the case where a high current consumption occurs in a load to which the power supply circuit 100 shown in FIG. 1 supplies electric power;

FIG. 3 is a waveform diagram showing examples of operation waveforms of the power supply-side amplifier “AU” shown in FIG. 1 in the case where the high current consumption occurs shown in FIG. 2;

FIG. 4 is a waveform diagram showing examples of operation waveforms of the ground-side amplifier “AD” shown in FIG. 1 in the case where the high current consumption occurs shown in FIG. 2;

FIG. 5 is a waveform diagram showing an example of the output voltage “VOUT” in the case where a high current consumption of a load to which the power supply circuit 100 shown in FIG. 1 supplies electric power stops;

FIG. 6 is a waveform diagram showing examples of operation waveforms of the power supply-side amplifier “AU” shown in FIG. 1 in the case where the high current consumption stops shown in FIG. 5; and

FIG. 7 is a waveform diagram showing examples of operation waveforms of the ground-side amplifier “AD” shown in FIG. 1 in the case where the high current consumption stops shown in FIG. 5.

### DETAILED DESCRIPTION

A power supply circuit according to an embodiment includes a voltage generating circuit that generates an output voltage responsive to a reference voltage and outputs the output voltage at a voltage output terminal. The power supply circuit includes a power supply-side resistor that receives a power supply-side detection voltage that is based on the output voltage at a first end thereof. The power supply circuit includes a power supply-side capacitor connected to a second end of the power supply-side resistor at a first end thereof and to a ground at a second end thereof. The power supply circuit includes a ground-side resistor connected to the voltage output terminal at a first end thereof. The power supply circuit includes a ground-side capacitor connected to a second end of the ground-side resistor at a first end thereof and to the ground at a second end thereof. The power supply circuit includes a power supply-side amplifier that is connected to the voltage output terminal at a non-inverting input terminal thereof and to the second end of the power supply-side resistor at an inverting input terminal thereof and outputs a power supply-side control signal at an output terminal thereof. The power supply circuit includes a ground-side amplifier that is connected to the second end of the ground-side resistor at a non-inverting input terminal thereof, receives a ground-side detection voltage that is based on the output voltage at an inverting input terminal thereof and outputs a ground-side control signal. The power supply circuit includes a power supply-side switch element that is connected to a power supply at a first end thereof and to the voltage output terminal at a second end thereof and is controlled by the power supply-side control signal. The power supply circuit includes a ground-side switch element that is connected to the voltage output terminal at a first end thereof and to the ground at a second end thereof and is controlled by the ground-side control signal.

### DETAILED DESCRIPTION OF THE INVENTION

In the following, an embodiment will be described with reference to the drawings.

### First Embodiment

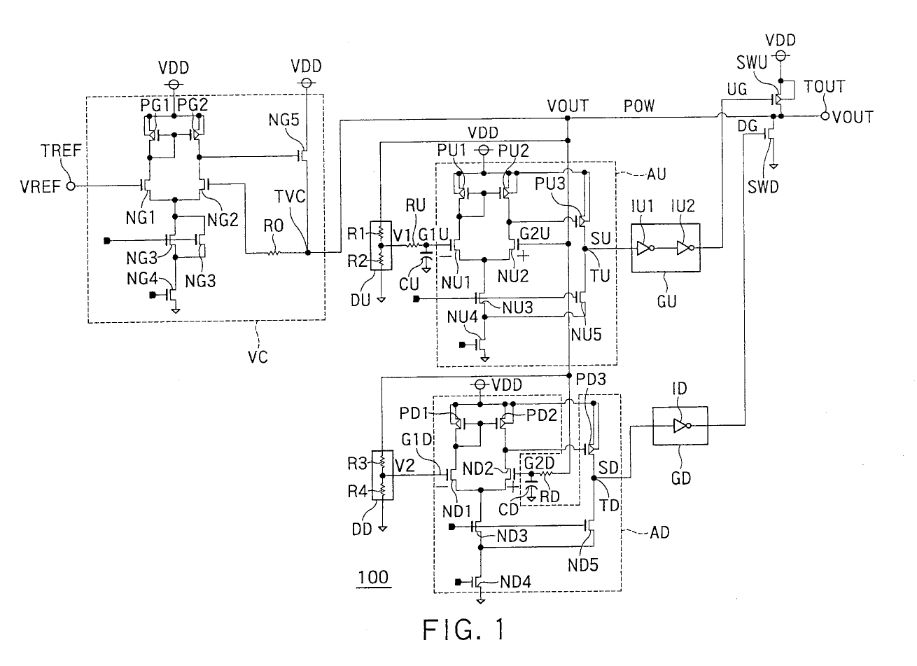

FIG. 1 is a circuit diagram showing an example of a configuration of a power supply circuit 100 according to a first embodiment.

As shown in FIG. 1, the power supply circuit 100 includes a voltage generating circuit “VC”, a power supply-side resistor “RU”, a power supply-side capacitor “Cu”, a ground-side resistor “RD”, a ground-side capacitor “CD”, a power supply-side amplifier “AU”, a ground-side amplifier “AD”, a power supply-side switch element “SWU”, a power supply-side voltage dividing circuit “DU”, a ground-side voltage dividing circuit “DD”, a power supply-side gate driver “GU”, and a ground-side gate driver “GD”.

The voltage generating circuit “VC” generates an output voltage “VOUT” responsive to a reference voltage “VREF” and outputs the output voltage “VOUT” at a voltage output terminal “TOUT”.

The voltage generating circuit “VC” has a first pMOS transistor “PG1”, a second pMOS transistor “PG2”, a first nMOS transistor “NG1”, a second nMOS transistor “NG2”, a third nMOS transistor “NG3”, a fourth nMOS transistor “NG4”, a fifth nMOS transistor “NG5” and an output resistor “RO”.

The first pMOS transistor “PG1” is connected to a power supply “VDD” at a source thereof and is diode-connected.

The second pMOS transistor “PG2” is connected to the power supply “VDD” at a source thereof and to a gate of the pMOS transistor “PG1” at a gate thereof.

The first nMOS transistor “NG1” is connected to a drain of the first pMOS transistor “PG1” at a drain thereof and to a reference voltage terminal “TREF”, to which the reference voltage “VREF” is applied, at a gate thereof.

The second nMOS transistor “NG2” is connected to a drain of the second pMOS transistor “PG2” at a drain thereof and to a source of the first nMOS transistor at a source thereof.

The third nMOS transistor “NG3” is connected to the source of the first nMOS transistor “NG1” at a drain thereof. The third nMOS transistor “NG3” is configured so that a predetermined voltage is applied to a gate thereof, and a predetermined current flows therethrough.

The fourth nMOS transistor “NG4” is connected between a source of the third nMOS transistor “NG3” and a ground and is configured to receive a signal that controls turning on and off thereof at a gate thereof.

The output resistor “RO” is connected between a gate of the second nMOS transistor “NG2” and the voltage output terminal “TOUT”.

The fifth nMOS transistor “NG5” is connected to the power supply “VDD” at a drain thereof and to the voltage output terminal “TOUT” at a source thereof.

The power supply-side voltage dividing circuit “DU” is connected between the voltage output terminal “TOUT” and the ground and is configured to output a power supply-side detection voltage “V1” obtained by dividing the output voltage “VOUT”.

As shown in FIG. 1, the power supply-side voltage dividing circuit “DU” has a first power supply-side voltage dividing resistor “R1” that is connected to the voltage output terminal “TOUT” at one end thereof and to one end of the power supply-side resistor “RU” at another end thereof, and a second power supply-side voltage dividing resistor “R2” connected between the another end of the first power supply-side voltage dividing resistor and the ground, for example.

The ground-side voltage dividing circuit “DD” is connected between the voltage output terminal “TOUT” and the ground and is configured to output a ground-side detection voltage “V2” obtained by dividing the output voltage “VOUT”.

As shown in FIG. 1, the ground-side voltage dividing circuit “DD” has a first ground-side voltage dividing resistor “R3” that is connected to the voltage output terminal “TOUT” at one end thereof and to an inverting input terminal of the ground-side amplifier “AD” at another end thereof, and a second ground-side voltage dividing resistor “R4” connected between the another end of the first ground-side voltage dividing resistor and the ground, for example.

The voltage division ratio of the power supply-side voltage dividing circuit “DU” is set to be equal to the voltage division ratio of the ground-side voltage dividing circuit “DD”, for example.

The power supply-side detection voltage “V1” and the ground-side detection voltage “V2” are set to be lower than the output voltage “VOUT”, for example.

The power supply-side resistor “RU” is connected to an output of the power supply-side voltage dividing circuit “DU” (the another end of the first power supply-side voltage dividing resistor “R1”) at one end thereof, for example. That is, the power supply-side resistor “RU” receives the power supply-side detection voltage “V1” that is based on the output voltage “VOUT” at the one end thereof.

The power supply-side capacitor “CU” is connected to another end of the power supply-side resistor “RU” at one end thereof and to the ground at another end thereof.

The ground-side resistor “RD” is connected to the voltage output terminal “TOUT” at one end thereof.

The resistance of the power supply-side resistor “RU” is set to be equal to the resistance of the ground-side resistor “RD”, for example.

The ground-side capacitor “CD” is connected to another end of the ground-side resistor “RD” at one end thereof and to the ground at another end thereof.

The capacitance of the power supply-side capacitor “CU” is set to be equal to the capacitance of the ground-side capacitor “CD”.

Since the resistance of the power supply-side resistor “RU” is set to be equal to the resistance of the ground-side resistor “RD”, and the capacitor of the power supply-side capacitor “CU” is set to be equal to the capacitance of the ground-side capacitor “CD” as described above, a pull-up phase and a pull-down phase can be aligned with each other, and a through-current can be suppressed. However, depending on the characteristics required by the design, the resistance of the power supply-side resistor “RU” and the resistance of the ground-side resistor “RD” can be set to be different, and the capacitance of the power supply-side capacitor “CU” and the capacitance of the ground-side capacitor “CD” can be set to be different so that the pull-up phase and the pull-down phase differs from each other.

The power supply-side amplifier “AU” is connected to the voltage output terminal “TOUT” at a non-inverting input terminal thereof and to another end of the power supply-side resistor “RU” at an inverting input terminal thereof and outputs a power supply-side control signal “SU” at an output terminal “TU” thereof.

As shown in FIG. 1, the power supply-side amplifier “AU” has a first power supply-side pMOS transistor “PU1”, a second power supply-side pMOS transistor “PU2”, a third power supply-side pMOS transistor “PU3”, a first power supply-side nMOS transistor “NU1”, a second power supply-side nMOS transistor “NU2”, a third power supply-side nMOS transistor “NU3”, a fourth power supply-side nMOS transistor “NU4” and a fifth power supply-side nMOS transistor “NU5”, for example.

The first power supply-side pMOS transistor “PU1” is connected to the power supply “VDD” at a source thereof and is diode-connected.

The second power supply-side pMOS transistor “PU2” is connected to the power supply “VDD” at a source thereof and to a gate of the first power supply-side pMOS transistor “PU1” at a gate thereof.

The first power supply-side nMOS transistor “NU1” is connected to a drain of the first power supply-side pMOS transistor “PU1” at a drain thereof and to the inverting input terminal of the power supply-side amplifier “AU” at a gate thereof.

The second power supply-side nMOS transistor “NU2” is connected to a drain of the second power supply-side pMOS transistor “PU2” at a drain thereof, to a source of the first power supply-side nMOS transistor “NU1” at a source thereof and to the non-inverting input terminal of the power supply-side amplifier “AU” at a gate thereof.

The third power supply-side nMOS transistor “NU3” is connected to the source of the first power supply-side nMOS transistor “NU1” at a drain thereof. The third power supply-side nMOS transistor “NU3” is configured so that a predetermined voltage is applied to a gate thereof, and a predetermined current flows therethrough.

The fourth power supply-side nMOS transistor “NU4” is connected between a source of the third power supply-side nMOS transistor “NU3” and the ground and is configured to receive a signal that controls turning on and off thereof at a gate thereof. In operation of the power supply-side amplifier “AU”, the fourth power supply-side nMOS transistor “NU4” is controlled to be in an on state.

The third power supply-side pMOS transistor “PU3” is connected to the power supply “VDD” at a source thereof, to the output terminal “TU” of the power supply-side amplifier “AU” at a drain thereof and to the drain of the second power supply-side pMOS transistor “PU2” at a gate thereof.

The fifth power supply-side nMOS transistor “NU5” is connected to the ground at a source thereof, to the output terminal “TU” of the power supply-side amplifier “AU” at a drain thereof and to the gate of the third power supply-side nMOS transistor “NU3” at a gate thereof.

The power supply-side gate driver “GU” controls the power supply-side switch element “SWU” with a signal “UG” in response to the power supply-side control signal “SU”.

As shown in FIG. 1, the power supply-side gate driver “GU” has a first power supply-side inverter “IU1” and a second power supply-side inverter “IU2”, for example.

The first power supply-side inverter “IU1” is connected to the output terminal “TU” of the power supply-side amplifier “AU” at an input thereof.

The second power supply-side inverter “IU2” is connected to an output of the first power supply-side inverter “IU1” at an input thereof and to a gate of a pMOS transistor (power supply-side switch element “SWU”) at an output thereof.

The ground-side amplifier “AD” is connected to another end of the ground-side resistor “RD” at a non-inverting input terminal thereof, receives the ground-side detection voltage “V2” that is based on the output voltage “VOUT” at the inverting input terminal thereof, and outputs a ground-side control signal “SD” at an output terminal “TD” thereof.

As shown in FIG. 1, the ground-side amplifier “AD” has a first ground-side pMOS transistor “PD1”, a second ground-side pMOS transistor “PD2”, a third ground-side pMOS transistor “PD3”, a first ground-side nMOS transistor “ND1”, a second ground-side nMOS transistor “ND2”, a third ground-side nMOS transistor “ND3”, a fourth ground-side nMOS transistor “ND4” and a fifth ground-side nMOS transistor “ND5”.

The first ground-side pMOS transistor “PD1” is connected to the power supply “VDD” at a source thereof and is diode-connected.

The second ground-side pMOS transistor “PD2” is connected to the power supply “VDD” at a source thereof and to a gate of the first ground-side pMOS transistor “PD1” at a gate thereof.

The first ground-side nMOS transistor “ND1” is connected to a drain of the first ground-side pMOS transistor “PD1” at a drain thereof and to the inverting input terminal of the ground-side amplifier “AD” at a gate thereof. In this embodiment, the first ground-side nMOS transistor “ND1” is connected to an output of the ground-side voltage dividing circuit “DD” (the another end of the first ground-side voltage dividing resistor “R3”) at the gate thereof.

The second ground-side nMOS transistor “ND2” is connected to a drain of the second ground-side pMOS transistor “PD2” at a drain thereof, to a source of the first ground-side nMOS transistor “ND1” at a source thereof and to the non-inverting input terminal of the ground-side amplifier “AD” (the one end of the ground-side resistor “RD”) at a gate thereof.

The third ground-side nMOS transistor “ND3” is connected to the source of the first power supply-side nMOS transistor “NU1” at a drain thereof. The third ground-side nMOS transistor “ND3” is configured so that a predetermined voltage is applied to a gate thereof, and a predetermined current flows therethrough.

The third ground-side pMOS transistor “PD3” is connected to the power supply “VDD” at a source thereof, to the output terminal “TD” of the ground-side amplifier “AD” at a drain thereof and to the drain of the second ground-side pMOS transistor “PD2” at a gate thereof.

The fourth ground-side nMOS transistor “ND4” is connected between a source of the third ground-side nMOS transistor “ND3” and the ground and receives a signal that controls turning on and off thereof at a gate thereof. In operation of the ground-side amplifier “AD”, the fourth ground-side nMOS transistor “ND4” is controlled to be in the on state.

The fifth ground-side nMOS transistor “ND5” is connected to the ground at a source thereof, to the output terminal “TD” of the power supply-side amplifier “AU” at a drain thereof and to the gate of the third ground-side nMOS transistor “ND3” at a gate thereof.

The ground-side gate driver “GD” controls a ground-side switch element “SWD” with a signal “DG” in response to the ground-side control signal “SD”.

As shown in FIG. 1, the ground-side gate driver “GD” has a ground-side inverter “ID”, for example.

The ground-side inverter “ID” is connected to the output terminal “TD” of the ground-side amplifier “AD” at an input thereof and to a gate of an nMOS transistor (ground-side switch element “SWD”) at an output thereof.

The power supply-side switch element “SWU” is connected to the power supply “VDD” at one end thereof and to the voltage output terminal “TOUT” at another end thereof. The power supply-side switch element “SWU” is turned on and off under the control of the power supply-side control signal “SU” (an output of the power supply-side gate driver “GU”).

As shown in FIG. 1, the power supply-side switch element “SWU” is a pMOS transistor that is connected to the power supply “VDD” at a source thereof and to the voltage output terminal “TOUT” at a drain thereof and has a gate voltage controlled by the power supply-side control signal “SU”, for example.

The ground-side switch element “SWD” is connected to the voltage output terminal “TOUT” at one end thereof and to the ground at another end thereof. The ground-side switch element “SWD” is turned on and off under the control of the ground-side control signal “SD” (an output of the ground-side gate driver “GD”).

As shown in FIG. 1, the ground-side switch element “SWD” is an nMOS transistor that is connected to the ground at a source thereof and to the voltage output terminal “TOUT” at a drain thereof and has a gate voltage controlled by the ground-side control signal “SD”, for example.

The capacity of the fifth nMOS transistor “NG5” described above to flow a current is set to be higher than the capacities of the power supply-side switch element “SWU” (a pMOS transistor) and the ground-side switch element “SWD” (an nMOS transistor) to flow a current.

In FIG. 1, a back gate of each pMOS transistor is connected to the source of the pMOS transistor.

Next, an example of an operation of the power supply circuit 100 configured as described above will be described.

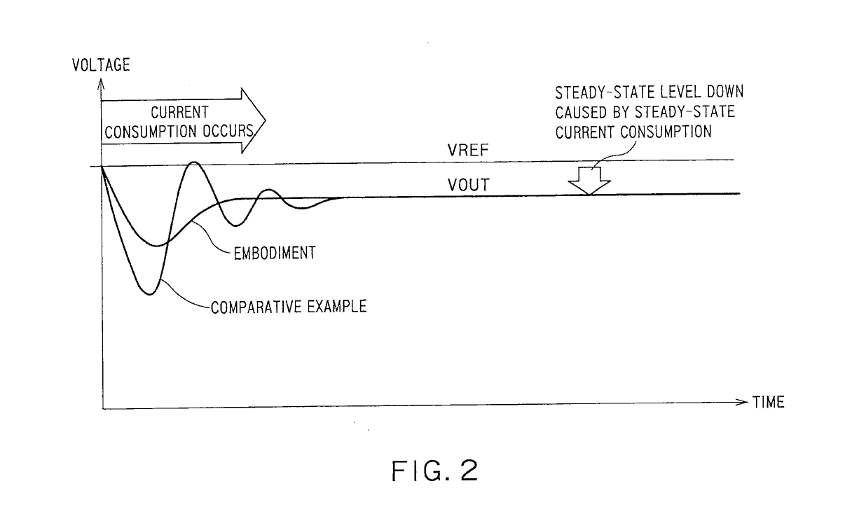

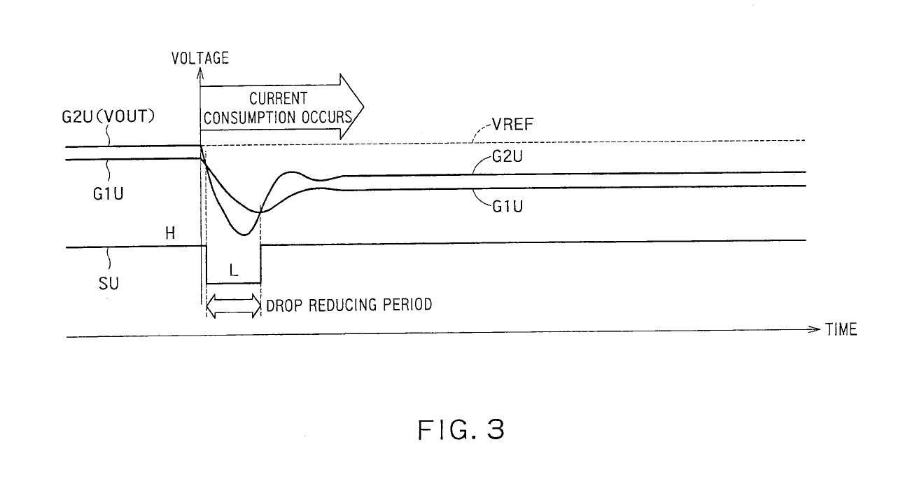

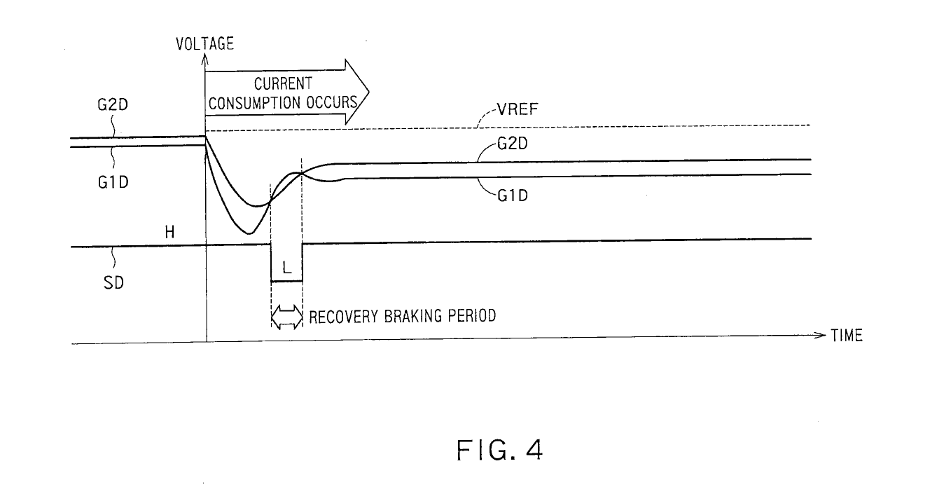

As an example, a case where a high current consumption occurs in a load to which the power supply circuit 100 supplies electric power will be first described. FIG. 2 is a waveform diagram showing an example of the output voltage “VOUT” in the case where a high current consumption occurs in a load to which the power supply circuit 100 shown in FIG. 1 supplies electric power. FIG. 3 is a waveform diagram showing examples of operation waveforms of the power supply-side amplifier “AU” shown in FIG. 1 in the case where the high current consumption occurs shown in FIG. 2. FIG. 4 is a waveform diagram showing examples of operation waveforms of the ground-side amplifier “AD” shown in FIG. 1 in the case where the high current consumption occurs shown in FIG. 2.

As shown in FIG. 2, for example, an abrupt increase of the current consumption causes a drop of the output voltage “VOUT”.

If a drop of the output voltage “VOUT” occurs as described above, a gate voltage “G2U” of the second power supply-side nMOS transistor “NU2” in the power supply-side amplifier “AU” first decreases, as shown in FIG. 3.

As shown in FIG. 3, when the drop of the output voltage “VOUT” occurs due to the abrupt increase of the current consumption, the level of a gate voltage “G1U” of the first power supply-side nMOS transistor “NU1” also decreases, but the decrease lags behind the decrease of the gate voltage “G2U” of the second power supply-side nMOS transistor “NU2” because the phase of the gate voltage “G1U” is shifted by the power supply-side resistor “RU” and the power supply-side capacitor “CU”.

The power supply-side amplifier “AU” detects the drop of the output voltage “VOUT” when the level of the gate voltage “G2U”, which is a feedback of the output voltage “VOUT”, decreases below the level of the gate voltage “G1U”, and outputs the power supply-side control signal “SU” responsive to the detection result.

The power supply-side control signal “SU” turns on the power supply-side switch element “SWU”. As a result, the output voltage “VOUT” increases (a drop reducing period).

As shown in FIG. 4, a recovery operation of the power supply circuit 100 then starts, and a gate voltage “G1D” (the ground-side detection voltage “V2”) of the first ground-side nMOS transistor “ND1” in the ground-side amplifier “AD” starts increasing.

In the case where the drop of the output voltage “VOUT” occurs due to the abrupt increase of the current consumption, the level of a gate voltage “G2D” of the second ground-side nMOS transistor “ND2” also increases, but the increase lags behind the increase of the gate voltage “G1D” of the first ground-side nMOS transistor “ND1” because the phase of the gate voltage “G2D” is shifted by the ground-side resistor “RD” and the ground-side capacitor “CD”.

The ground-side amplifier “AD” detects the recovery operation when the level of the gate voltage “G1D” increases above the level of the gate voltage “G2D”, and outputs the ground-side control signal “SD” responsive to the detection result. The ground-side control signal “SD” turns on the ground-side switch element “SWD”. As a result, an increase of the output voltage “VOUT” is suppressed (a recovery braking period).

In this way, a power supply drop and an overshoot that would otherwise occur when a high current consumption occurs are prevented, and therefore, a ringing is prevented. And an overdrive that would otherwise occur when the high current consumption stops is also prevented.

In particular, if the output voltage “VOUT” has not reached a target level when the recovery braking period ends, the recovery operation starts again. And if an abrupt recovery starts, the ground-side switch element “SWD” brakes the recovery operation.

Thus, the ground-side switch element “SWD” can start operating before the target level is reached. As a result, the recovery operation can be braked, and the output voltage “VOUT” can be slowly brought back to the target level.

As a result, an overcharge can be prevented, a ringing can be prevented, and the time required to recover and stabilize the level of the output voltage “VOUT” having once dropped can be reduced compared with a comparative example (FIG. 2).

In addition, the capability of the power supply-side switch element “SWU” can be enhanced, and as a result, a drop of the output voltage “VOUT” can be suppressed.

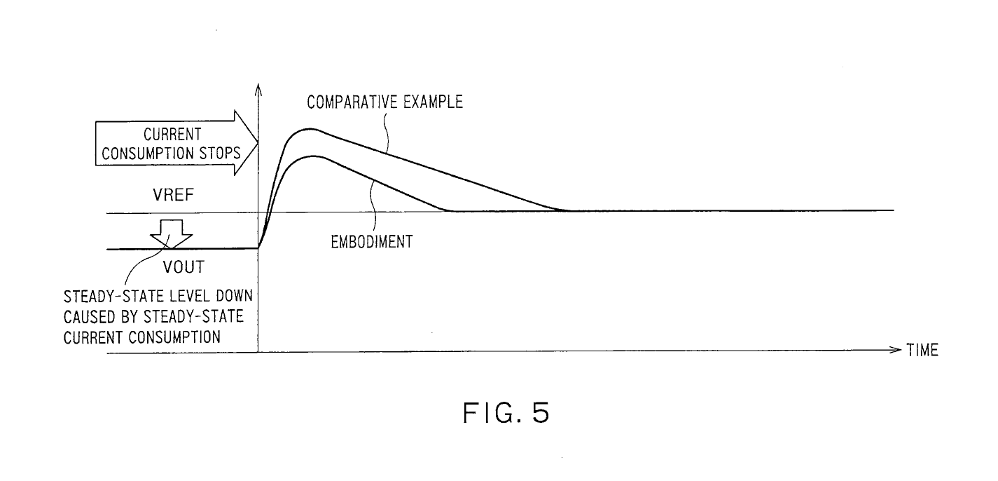

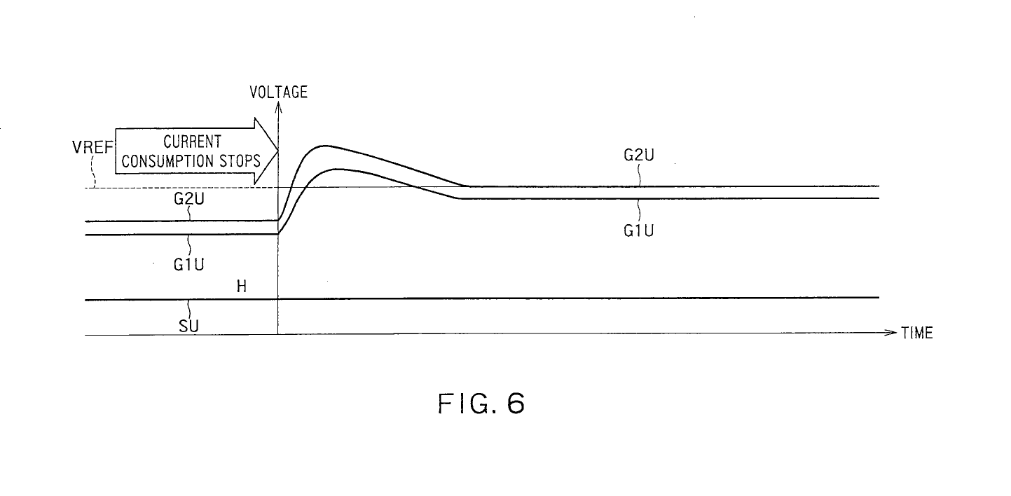

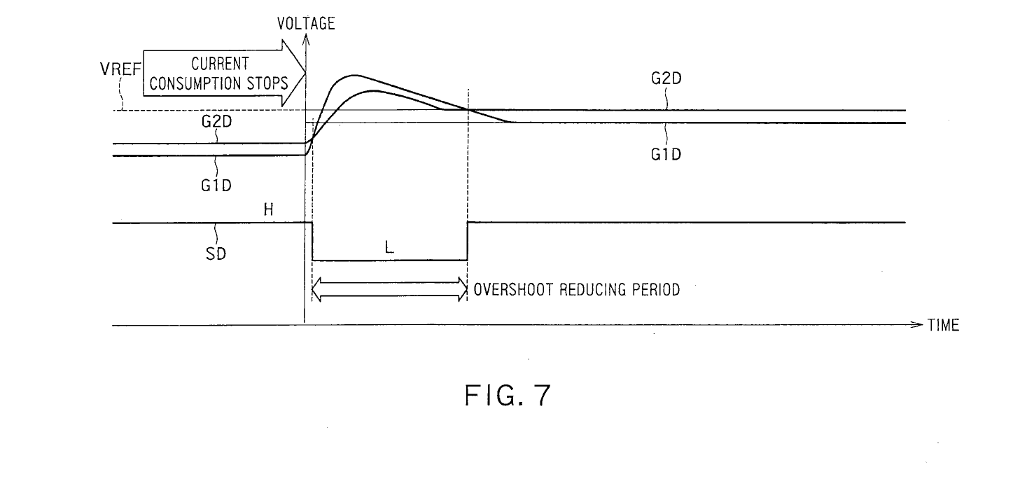

Next, as an example, a case where a high current consumption of a load to which the power supply circuit 100 supplies electric power stops will be described. FIG. 5 is a waveform diagram showing an example of the output voltage “VOUT” in the case where a high current consumption of a load to which the power supply circuit 100 shown in FIG. 1 supplies electric power stops. FIG. 6 is a waveform diagram showing examples of operation waveforms of the power supply-side amplifier “AU” shown in FIG. 1 in the case where the high current consumption stops shown in FIG. 5. FIG. 7 is a waveform diagram showing examples of operation waveforms of the ground-side amplifier “AD” shown in FIG. 1 in the case where the high current consumption stops shown in FIG. 5.

As shown in FIG. 5, for example, when a current consumption stops, the output voltage “VOUT” increases.

When the output voltage “VOUT” increases as described above, the gate voltage “G2U”, which is a feedback of the output voltage “VOUT”, and the gate voltage “G1U” also increase as shown in FIG. 6.

Since the magnitude relationship between the gate voltage “G2U” and the gate voltage “G1U” is maintained, the power supply-side amplifier “AU” does not operate, and the level of the power supply-side control signal “SU” is maintained. The power supply-side control signal “SU” keeps the power supply-side switch element “SWU” in an off state.

As shown in FIG. 7, when the current consumption stops, the gate voltage “G1D” of the first ground-side nMOS transistor “ND1” in the ground-side amplifier “AD” starts increasing.

The gate voltage “G2D” of the second ground-side nMOS transistor “ND2” in the ground-side amplifier “AD” also starts increasing, but the increase lags behind the increase of the gate voltage “G1D” of the first ground-side nMOS transistor “ND1” because the phase of the gate voltage “G2D” is shifted by the ground-side resistor “RD” and the ground-side capacitor “CD”.

The ground-side amplifier “AD” detects the recovery operation of the power supply circuit 100 when the level of the gate voltage “G1D” increases above the level of the gate voltage “G2D”, and outputs the ground-side control signal “SD” responsive to the detection result. The ground-side control signal “SD” turns on the ground-side switch element “SWD”. As a result, an increase of the output voltage “VOUT” is suppressed (an overshoot reducing period).

In this way, a drop of the output voltage “VOUT” and an overshoot of the output voltage “VOUT” that would otherwise occur when a high current consumption occurs are prevented, and therefore, a ringing is prevented. And an overdrive that would otherwise occur when the high current consumption stops is also prevented.

Since the output voltage “VOUT” is slowly brought back to the target level as described above, a ringing can be suppressed, and the time required to recover and stabilize the level of the output voltage “VOUT” having once dropped can be reduced.

In particular, as described above, the power supply-side detection voltage “V1” input to the power supply-side amplifier “AU” that detects a drop of the output voltage “VOUT” and the ground-side detection voltage “V2” input to the ground-side amplifier “AD” that detects a recovery are set to be lower than the output voltage “VOUT” (5% or so, for example). Therefore, the power supply-side switch element “SWU” or the ground-side switch element “SWD” can be prevented from being kept in the on state.

As described above, the power supply circuit according to the embodiment can stabilize the output voltage.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power supply circuit, comprising:
a voltage generating circuit that generates an output voltage responsive to a reference voltage and outputs the output voltage at a voltage output terminal;
a power supply-side resistor that receives a power supply-side detection voltage that is based on the output voltage at a first end thereof;
a power supply-side capacitor connected to a second end of the power supply-side resistor at a first end thereof and to a ground at a second end thereof;
a ground-side resistor connected to the voltage output terminal at a first end thereof;
a ground-side capacitor connected to a second end of the ground-side resistor at a first end thereof and to the ground at a second end thereof;
a power supply-side amplifier that is connected to the voltage output terminal at a non-inverting input terminal thereof and to the second end of the power supply-side resistor at an inverting input terminal thereof and outputs a power supply-side control signal at an output terminal thereof;
a ground-side amplifier that is connected to the second end of the ground-side resistor at a non-inverting input terminal thereof, receives a ground-side detection voltage that is based on the output voltage at an inverting input terminal thereof and outputs a ground-side control signal;
a power supply-side switch element that is connected to a power supply at a first end thereof and to the voltage output terminal at a second end thereof and is controlled by the power supply-side control signal; and
a ground-side switch element that is connected to the voltage output terminal at a first end thereof and to the ground at a second end thereof and is controlled by the ground-side control signal.

2. The power supply circuit according to claim 1, wherein the power supply-side detection voltage and the ground-side detection voltage are lower than the output voltage.

3. The power supply circuit according to claim 1, wherein a resistance of the power supply-side resistor is set to be equal to a resistance of the ground-side resistor, and
a capacitance of the power supply-side capacitor is set to be equal to a capacitance of the ground-side capacitor.

4. The power supply circuit according to claim 1, further comprising:
a power supply-side voltage dividing circuit that is connected between the voltage output terminal and the ground and outputs the power supply-side detection voltage obtained by dividing the output voltage; and
a ground-side voltage dividing circuit that is connected between the voltage output terminal and the ground and outputs the power ground-side detection voltage obtained by dividing the output voltage.

5. The power supply circuit according to claim 1, further comprising:
a power supply-side gate driver that controls the power supply-side switch element in response to the power supply-side control signal; and
a ground-side gate driver that controls the ground-side switch element in response to the ground-side control signal.

6. The power supply circuit according to claim 1, wherein the power supply-side amplifier has:
a first power supply-side pMOS transistor that is connected to the power supply at a source thereof and is diode-connected;
a second power supply-side pMOS transistor connected to the power supply at a source thereof and to a gate of the first power supply-side pMOS transistor at a gate thereof;
a first power supply-side nMOS transistor connected to a drain of the first power supply-side pMOS transistor at a drain thereof and to the inverting input terminal of the power supply-side amplifier at a gate thereof;
a second power supply-side nMOS transistor connected to a drain of the second power supply-side pMOS transistor at a drain thereof, connected to the source of the first power supply-side nMOS transistor at a source thereof and to the non-inverting input terminal of the power supply-side amplifier at a gate thereof;
a third power supply-side nMOS transistor connected to a source of the first power supply-side nMOS transistor at a drain thereof, a predetermined voltage being applied to a gate of the third power supply-side nMOS transistor;
a fourth power supply-side nMOS transistor that is connected between a source of the third power supply-side nMOS transistor and the ground and receives a signal that controls turning on and off thereof at a gate thereof;
a third power supply-side pMOS transistor connected to the power supply at a source thereof, to the output terminal of the power supply-side amplifier at a drain thereof and to the drain of the second power supply-side pMOS transistor at a gate thereof; and
a fifth power supply-side nMOS transistor connected to the ground at a source thereof, to the output terminal of the power supply-side amplifier at a drain thereof and to the gate of the third power supply-side nMOS transistor at a gate thereof.

7. The power supply circuit according to claim 1, wherein the ground-side amplifier has:
a first ground-side pMOS transistor that is connected to the power supply at a source thereof and is diode-connected;
a second ground-side pMOS transistor connected to the power supply at a source thereof and to a gate of the first ground-side pMOS transistor at a gate thereof;
a first ground-side nMOS transistor connected to a drain of the first ground-side pMOS transistor at a drain thereof and to the inverting input terminal of the ground-side amplifier at a gate thereof;
a second ground-side nMOS transistor connected to a drain of the second ground-side pMOS transistor at a drain thereof, connected to the source of the first ground-side nMOS transistor at a source thereof and to the non-inverting input terminal of the ground-side amplifier at a gate thereof;
a third ground-side nMOS transistor connected to a source of the first ground-side nMOS transistor at a drain thereof, a predetermined voltage being applied to a gate of the third ground-side nMOS transistor;
a fourth ground-side nMOS transistor that is connected between a source of the third ground-side nMOS transistor and the ground and receives a signal that controls turning on and off thereof at a gate thereof;
a third ground-side pMOS transistor connected to the power supply at a source thereof, to the output terminal of the ground-side amplifier at a drain thereof and to the drain of the second ground-side pMOS transistor at a gate thereof; and
a fifth ground-side nMOS transistor connected to the ground at a source thereof, to the output terminal of the ground-side amplifier at a drain thereof and to the gate of the third ground-side nMOS transistor at a gate thereof.

8. The power supply circuit according to claim 1,
wherein the power supply-side switch element is a pMOS transistor connected to the power supply at a source thereof and to the voltage output terminal at a drain thereof, a gate voltage of the pMOS transistor being controlled by the power supply-side control signal, and
wherein the ground-side switch element is a nMOS transistor connected to the ground at a source thereof and to the voltage output terminal at a drain thereof, a gate voltage of the nMOS transistor being controlled by the ground-side control signal.

9. The power supply circuit according to claim 5,
wherein the power supply-side gate driver has:
a first power supply-side inverter connected to the output terminal of the power supply-side amplifier at an input thereof; and
a second power supply-side inverter connected to an output of the first power supply-side inverter at an input thereof and to a gate of the pMOS transistor at an output thereof, and
wherein the power supply-side gate driver has:
a ground-side inverter connected to the output terminal of the ground-side amplifier at an input thereof, and connected to a gate of the nMOS transistor at an output thereof.

10. The power supply circuit according to claim 1, wherein the voltage generating circuit has:
a first pMOS transistor that is connected to the power supply at a source thereof and is diode-connected;
a second pMOS transistor connected to the power supply at a source thereof and to a gate of the first pMOS transistor at a gate thereof;
a first nMOS transistor connected to a drain of the first pMOS transistor at a drain thereof and to a reference voltage terminal, to which the reference voltage is applied, at a gate thereof;
a second nMOS transistor connected to a drain of the second pMOS transistor at a drain thereof and to a source of the first nMOS transistor at a source thereof;
a third nMOS transistor connected to the source of the first nMOS transistor at a drain thereof, a predetermined voltage being applied to a gate of the third nMOS transistor;
a fourth nMOS transistor that is connected between a source of the third nMOS transistor and the ground and receives a signal that controls turning on and off thereof at a gate thereof;
an output resistor connected between a gate of the second nMOS transistor and the voltage output terminal; and
a fifth nMOS transistor connected to the power supply at a drain thereof and to the voltage output terminal at a source thereof.

11. The power supply circuit according to claim 10, wherein a capacity of the fifth nMOS transistor to flow a current is set to be higher than capacities of the power supply-side switch element and the ground-side switch element to flow a current.

12. The power supply circuit according to claim 4,
wherein the power supply-side voltage dividing circuit has:
a first power supply-side voltage dividing resistor connected to the voltage output terminal at a first end thereof and to the first end of the power supply-side resistor at a second end thereof; and
a second power supply-side voltage dividing resistor connected between the second end of the first power supply-side voltage dividing resistor and the ground, and
wherein the ground-side voltage dividing circuit has:
a first ground-side voltage dividing resistor connected to the voltage output terminal at a first end thereof and to the inverting input of the ground-side amplifier at a second end thereof; and
a second ground-side voltage dividing resistor connected between the second end of the first ground-side voltage dividing resistor and the ground.

13. The power supply circuit according to claim 4, wherein a voltage division ratio of the power supply-side voltage dividing circuit is set to be equal to a voltage division ratio of the ground-side voltage dividing circuit.

14. A power supply circuit, comprising:
a voltage generating circuit that generates an output voltage responsive to a reference voltage and outputs the output voltage at a voltage output terminal;
a power supply-side resistor that receives a power supply-side detection voltage that is based on the output voltage at a first end thereof;
a power supply-side capacitor connected to a second end of the power supply-side resistor at a first end thereof and to a ground at a second end thereof
a power supply-side amplifier that is connected to the voltage output terminal at a non-inverting input terminal thereof and to the second end of the power supply-side resistor at an inverting input terminal thereof and outputs a power supply-side control signal at an output terminal thereof; and
a power supply-side switch element that is connected to a power supply at a first end thereof and to the voltage output terminal at a second end thereof and is controlled by the power supply-side control signal.

15. The power supply circuit according to claim 14, wherein the power supply-side detection voltage is lower than the output voltage.

16. The power supply circuit according to claim 14, further comprising:
a power supply-side voltage dividing circuit that is connected between the voltage output terminal and the ground and outputs the power supply-side detection voltage obtained by dividing the output voltage.

17. A power supply circuit, comprising:
a voltage generating circuit that generates an output voltage responsive to a reference voltage and outputs the output voltage at a voltage output terminal;
a ground-side resistor connected to the voltage output terminal at a first end thereof;
a ground-side capacitor connected to a second end of the ground-side resistor at a first end thereof and to the ground at a second end thereof;
a ground-side amplifier that is connected to the second end of the ground-side resistor at a non-inverting input terminal thereof, receives a ground-side detection voltage that is based on the output voltage at an inverting input terminal thereof and outputs a ground-side control signal; and
a ground-side switch element that is connected to the voltage output terminal at a first end thereof and to the ground at a second end thereof and is controlled by the ground-side control signal.

18. The power supply circuit according to claim 17, wherein the ground-side detection voltage is lower than the output voltage.

19. The power supply circuit according to claim 17, further comprising:
a ground-side voltage dividing circuit that is connected between the voltage output terminal and the ground and outputs the power ground-side detection voltage obtained by dividing the output voltage.
